(19) United States
(12) Patent Application Publication
(10) Pub. No.: US 2023/0235853 A1
(43) Pub. Date: Jul. 27, 2023

(54) Reinforced Plastic Air Storage Cylinder

(71) Applicants: WAL Low Carbon Technology (Anhui) Co., Ltd., Hefei (CN); WAL Fuel Systems USA Inc., Livonia, MI (US)

(72) Inventors: Xinyang Pu, Hefei (CN); Xiaohu Huang, Hefei (CN); Jun Xu, Hefei (CN); Xiankai Song, Livonia, MI (US); Weifeng Li, Hefei (CN); Chenghu Zhang, Hefei (CN)

(21) Appl. No.: 18/149,471

(22) Filed: Jan. 3, 2023

(30) Foreign Application Priority Data
Jan. 21, 2022 (CN) 202210071035.9

(51) Int. Cl. F17C 1/16

(52) U.S. Cl. CPC F17C 1/16; F17C 2201/0109; F17C 2221/031; F17C 2203/012; F17C 2203/066; F17C 2270/0178

(57) ABSTRACT

A reinforced plastic air storage cylinder, including an upper shell comprising a first inner volume, a first inner wall defining the first inner volume, and a first outer frame comprising reinforcing ribs connected to an exterior surface of the first inner wall to provide structural support thereto, wherein the first inner wall comprises a plurality of arc segments connected together to form petal-like structures wherein the plurality of arc segments of the first inner wall forms a plurality of peaks projecting into the first inner volume at locations where adjacent arc segments of the plurality of arc segments of the first inner wall connect to one another; a first center column positioned in the first inner volume; a first set of tensile ribs; and a lower shell comprising a second inner volume.

### CROSS-REFERENCE TO RELATED APPLICATION(S)

This application claims priority to and the benefit of Chinese Application No. 202210071035.9, filed on Jan. 21, 2022, the entire disclosure of which is hereby incorporated by reference.

### TECHNICAL FIELD

The present disclosure relates to the technical field of automobile parts, specifically to a reinforced plastic air storage cylinder.

### BACKGROUND

In recent years, with the transformation of the national economic structure and the advancement of new emission standards, major automobile manufacturers are facing great pressure to upgrade their products. The main upgrading trend of commercial truck products is lightweight. Lightweight has a great promoting effect in automobile safety, efficient transportation, energy conservation, and emission reduction. Lightweight is to take into account the requirements of the overall quality and input cost of the automobile on the premise of ensuring comprehensive performance indexes of the automobile such as strength, safety, and reliability, so as to minimize the weight of each part. Reducing the weight of the automobile can greatly reduce the fuel consumption, thereby reducing the emission of harmful substances, and with a post-treatment system, the comprehensive fuel consumption of the automobile can be controlled within the new emission standard.

Air storage cylinder is an important energy storage component in the braking and horn systems of automobiles. The air storage cylinder can store air pressed by an air compressor and release an air flow with high energy when needed, so as to meet working requirements of the braking and horn systems. Therefore, in a normal case, the air pressure in the air storage cylinder will be greatly higher than a normal atmospheric pressure, which also puts forward high requirements for the structural strength of the air storage cylinder itself. A current mainstream method for the lightweight of the air storage cylinder is to use a plastic material to replace a conventional steel material. However, the plastic material is affected by its own physical and chemical properties, so that the structural strength of plastic air storage cylinders produced by most manufacturers cannot meet normal use requirements, or the production cost is too high to achieve mass production. As a result, the plastic air storage cylinder is rarely used on automobiles on the market.

### SUMMARY

The purpose of the present disclosure is to provide a plastic air storage cylinder to solve the above defects.

In order to achieve the above purpose, the present disclosure provides the following technical solutions.

A reinforced air storage cylinder comprising: an upper shell comprising a first inner volume, a first inner wall defining the first inner volume, and a first outer frame comprising reinforcing ribs connected to an exterior surface of the first inner wall to provide structural support thereto, wherein the first inner wall comprises a plurality of arc segments connected together to form petal-like structures wherein the plurality of arc segments of the first inner wall forms a plurality of peaks projecting into the first inner volume at locations where adjacent arc segments of the plurality of arc segments of the first inner wall connect to one another; a first center column positioned in the first inner volume; a first set of tensile ribs wherein each tensile rib of the first set of tensile ribs comprises one end connecting to the first center column and an opposite end extending in a radial direction away from the first center column and securing to the first inner wall proximate a peak of the plurality of peaks of the first inner wall; and a lower shell comprising a second inner volume.

In one implementation, the plurality of arc segments of the first inner wall comprises at least five arc segments.

In one implementation, the first center column extends along an axial direction; a cross-sectional shape of the first center column is a circle or a polygon having one side for each arc segment of the plurality of arc segments of the first inner wall, wherein a cross section corresponding to the cross-sectional shape extends perpendicular to the axial direction.

In one implementation, the lower shell further comprises: a second inner wall defining the second inner volume, wherein the second inner wall comprises a plurality of arc segments connected together to form petal-like structures wherein the plurality of arc segments of the second inner wall forms a plurality of peaks projecting into the second inner volume at locations where adjacent arc segments of the plurality of arc segments of the second inner wall connect to one another; a second outer frame comprising reinforcing ribs connected to an exterior surface of the second inner wall to provide structural support thereto; a second center column positioned in the second inner volume; and a second set of tensile ribs wherein each tensile rib of the second set of tensile ribs comprises one end connecting to the second center column and an opposite end extending in a radial direction away from the second center column and securing to the second inner wall proximate a peak of the plurality of peaks of the second inner wall.

In one implementation, the reinforced air storage cylinder further comprises at least one intermediate shell comprising a third inner volume, wherein the upper shell closes off one end of the at least one intermediate shell and the lower shell closes off an opposite end of the at least one intermediate shell.

In one implementation, the at least one intermediate shell further comprises: a third inner wall defining the third inner volume, wherein the third inner wall comprises a plurality of arc segments connected together to form petal-like structures wherein the plurality of arc segments of the third inner wall forms a plurality of peaks projecting into the third inner volume at locations where adjacent arc segments of the plurality of arc segments of the third inner wall connect to one another; a third outer frame comprising reinforcing ribs connected to an exterior surface of the third inner wall to provide structural support thereto; a third center column positioned in the third inner volume; and a third set of tensile ribs wherein each tensile rib of the third set of tensile ribs comprises one end connecting to the third center column and an opposite end extending in a radial direction away from the third center column and securing to the third inner wall proximate a peak of the plurality of peaks of the third inner wall.

In one implementation, the opposite end of each tensile rib of at least one of the first, second, and third set of tensile ribs branches into two rib segments that capture therebetween the peak of the plurality of peaks of the first, second, and third inner wall corresponding thereto.

In one implementation, the upper shell is connected to the at least one intermediate shell by at least one of a fastener or a welding connection; and the lower shell is connected to the at least one intermediate shell by at least one of a fastener or a welding connection.

In one implementation, the reinforced air storage cylinder further comprises a separation closure head comprising a wall extending substantially orthogonal to a central axis of the at least one intermediate shell so as to axially divide the at least one intermediate shell into two cavities.

In one implementation, an outer perimeter of the separation closure head extends obliquely to meet the third inner wall.

In one implementation, the separation closure head is in one shape selected from the group consisting of a hemisphere shape, a flat plate shape, a dish shape, a cone shape, and a trapezoid shape.

In one implementation, the reinforcing ribs are arranged to form at least one pattern selected from the group consisting of a radial arc pattern, a diamond pattern, a cross pattern, a honeycomb pattern, a square pattern, and a parallel pattern.

In one implementation, the reinforcing ribs are arranged to form multiple patterns comprising the cross pattern and the radial arc pattern.

The beneficial effects of the present disclosure are as follows. The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Obviously, the described embodiments are only a part of the embodiments of the present disclosure, but not all of the embodiments. Based on the embodiments of the present disclosure, all other embodiments obtained by those of ordinary skill in the art without creative effort shall fall within the protection scope of the present disclosure. For example, in the drawings, the reinforced plastic air storage cylinder has two cavities; however, it may be modified to include more cavities by adding more separation closure heads or reduced to a single cavity by removing the separation closure head.

The present disclosure provides a reinforced plastic air storage cylinder. By arranging the tensile ribs and the central columns inside the shells of the air storage cylinder and arranging the reinforcing ribs outside the shells, the structural strength of the plastic air storage cylinder can be greatly improved, so that mass production of the plastic air storage cylinder can be achieved and the usage requirements in various systems of automobiles can be met. The uniquely designed petal-like structures can greatly reduce the curvature radius of the outer wall of each shell and improve the structural strength of the outer wall of the shell. The W-shaped separation closure head can cope with the impact of air flow generated by small and large cavities in the air storage cylinder in inflating and deflating processes and prevent the air flow from breaking through the closure head and then damaging the structure of the air storage cylinder. The welding bosses are additionally arranged on the welding ribs in the ladder-shaped welding surfaces. On the one hand, the welding area may be enlarged. On the other hand, when the welding bosses and the welding ribs are simultaneously softened, excess overflowing materials may be squeezed to both sides for filling. Compared with a single welding rib, this structure will achieve a better welding effect. The Y-shaped ribs may be arranged between the separation closure head and the adjacent welding surfaces, which can effectively improve the strength of the separation closure head. At the same time, the Y-shaped ribs can effectively improve the fluidity of plastic during injection molding of a product, thereby ensuring the size stability. The reinforced plastic air storage cylinder overall has the features of light weight, low cost, high structural strength, and the like; the objective of lightweight design of an air storage cylinder is achieved; and the air storage cylinder has an extremely high popularization significance.

### BRIEF DESCRIPTION OF DRAWINGS

In order to explain the embodiments of the present disclosure or the technical solutions in the prior art more clearly, the following briefly introduces the accompanying drawings that need to be used in the description of the embodiments or the prior art. Obviously, the accompanying drawings in the following description are only some embodiments of the present disclosure. For those of ordinary skill in the art, other drawings can also be obtained according to these drawings without creative effort.

FIG. 1: a schematic structural diagram of the present disclosure;

FIG. 2: a cross-sectional view of the present disclosure;

FIG. 3: a schematic structural diagram of an upper shell of the present disclosure;

FIG. 4: a cross-sectional view of the upper shell of the present disclosure;

FIG. 5: a schematic structural diagram of an intermediate shell of the present disclosure;

FIG. 6: a schematic structural diagram of a second tensile rib of the present disclosure;

FIG. 7: a schematic structural diagram of a ladder-shaped welding surface of the present disclosure;

FIG. 8: a schematic structural diagram of a parallel-shaped welding surface of the present disclosure;

FIG. 9: a schematic structural diagram of a bolt of the present disclosure;

FIG. 10: a cross-sectional view of the bolt of the present disclosure;

FIG. 11: a schematic structural diagram of an air inlet/outlet joint of the present disclosure;

FIG. 12: a cross-sectional view of the air inlet/outlet joint of the present disclosure.

### REFERENCE NUMBERS IN THE DRAWINGS

1. upper shell; 11. end closure head; 12. mounting seat hole; 121. asterisk-shaped reinforcing rib; 13. drainage opening; 14. bolt; 15. bush ring; 16. nut; 161. double-peak knurled thread; 17. air inlet/outlet joint; 171. three-peak knurled thread; 172. cavity; 173. sealing ring; 2. intermediate shell; 3. lower shell; 41. first tensile rib; 411. flange; 42. second tensile rib; 421. Y-shaped rib; 43. gradually rising arc surface; 51. upper shell center column; 52. intermediate shell center column; 53. lower shell center column; 6. petal-like structure; 61. small arc surface; 7. welding surface; 71. ladder-shaped welding surface; 711. welding boss; 72. parallel welding surface; 721. inner baffle plate; 73. outer baffle plate; 74. welding rib; 75. connecting lug; 8. reinforcing rib; 9. separation closure head.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure, but not all of the embodiments. Based on the embodiments of the present disclosure, all other embodiments obtained by those of ordinary skill in the art without creative effort shall fall within the protection scope of the present disclosure.

It should be noted in the embodiments of the present disclosure that, in the description of the present disclosure, orientations or positional relationships indicated by the terms “radial,” “axial,” “upper,” “lower,” “inner,” “outer,” “front,” “rear,” “left,” “right,” “center” and the like orientations or positional relationships shown in the drawings, which are only for convenience of description and do not indicate or imply a device or elements need to have a particular orientation, be constructed, and be operated in a particular orientation and are therefore not to be construed as limitations to the present disclosure.

In addition, it should be noted in the embodiments of the present disclosure that, in the description of the present disclosure, unless otherwise expressly specified and limited, the terms “set,” “mounted,” “connected” and “coupled” should be understood in a broad sense. For example, it may be a fixed connection, a detachable connection, or an integral connection; it may be a mechanical connection; it may be a direct connection, or an indirect connection through an intermediate medium, and it may be internal communication between two elements.

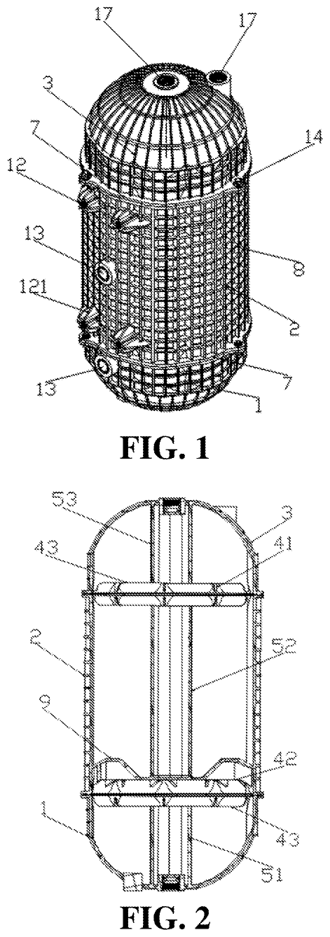

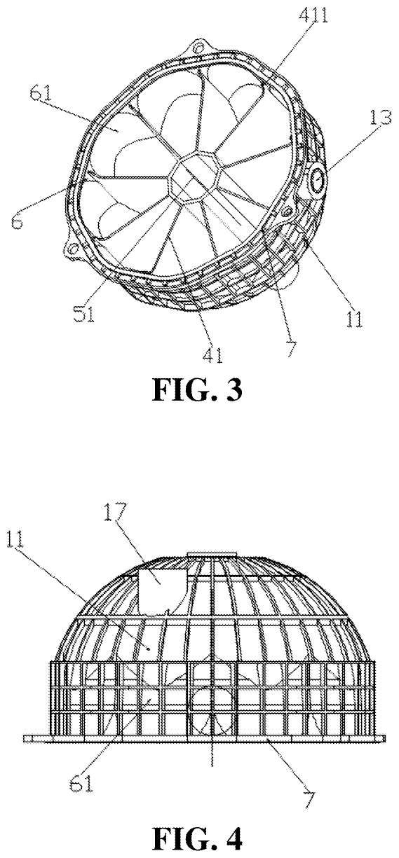

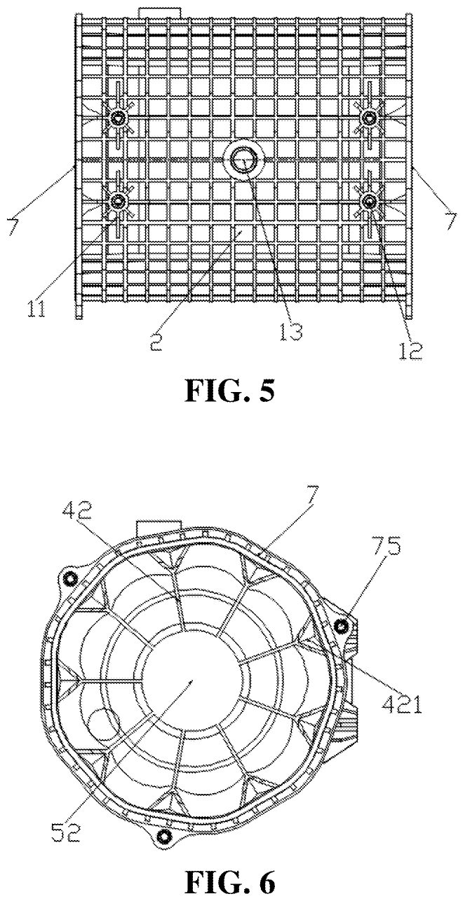

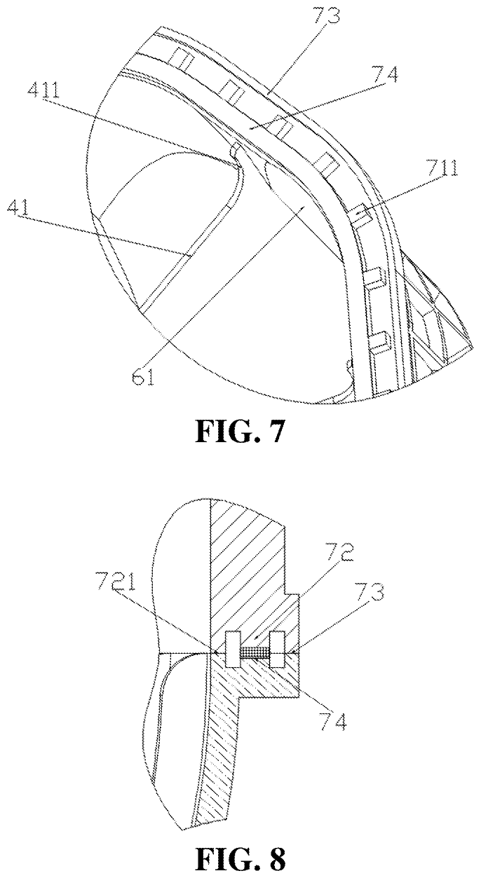

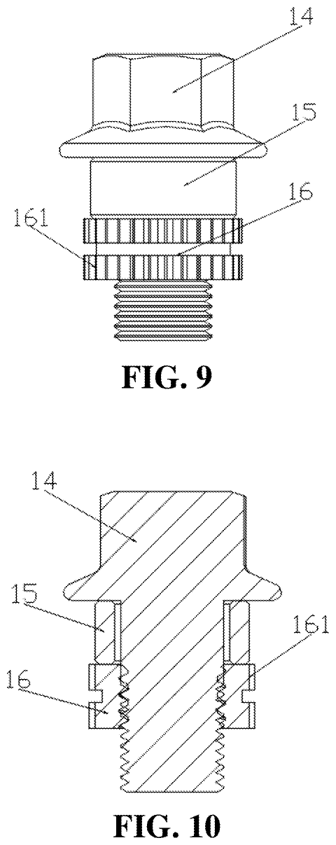

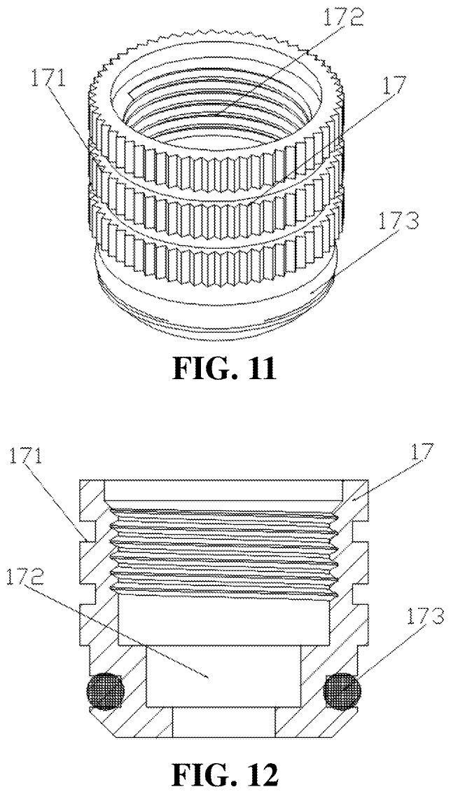

As shown in FIGS. 1-12, a reinforced plastic air storage cylinder may include an upper shell 1, an intermediate shell 2, and a lower shell 3. The upper shell 1 and the lower shell 3 are arranged at both ends of the intermediate shell 2. An end of an inner cavity of the intermediate shell 2 connected to the upper shell 1 may be provided with a separation closure head 9; the separation closure head 9 divides the upper shell 1, the intermediate shell 2, and the lower shell 3 into two cavities with different sizes. The large cavity can complete the work with high demand for gas energy such as driving brake, and the small cavity can complete the work with low demand for gas energy such as parking brake. The upper shell 1 and the lower shell 3 are both provided with end closure heads 11. The end closure heads 11 and the separation closure head 9 may be of any one shape of a hemisphere shape, a flat plate shape, a dish shape, a cone shape, and a trapezoid shape. In addition, the separation closure head 9 may also be a combination of various structures. For example, the middle position of the separation closure head 9 may be a trapezoid, and an edge position of the separation closure head 9 is obliquely connected to a petal-like structure 6, so that the separation closure head 9 forms a W-shaped structure. The separation closure head 9 separates an inner cavity of the air storage cylinder into small and large cavities, which will generate air flow impact during air feeding. As the middle position of the separation closure head 9 is a trapezoid, and the whole structure is W-shaped, it improves the structural strength of the separation closure head 9, thus preventing possible damage to the separation closure head 9 caused by too large air flow.

Tensile ribs are arranged in inner cavities of the upper shell 1, the intermediate shell 2, and the lower shell 3, and a thickness of each tensile rib may be 1 mm-5 mm. Center columns are arranged in the inner cavities of the upper shell 1, the intermediate shell 2, and the lower shell 3. One end of each tensile rib is connected to inner walls of the upper shell 1, the intermediate shell 2, and the lower shell 3, and the other end of the tensile rib is connected to outer walls of the center columns. The tensile ribs, the outer walls of the shells, and the center columns form a stable triangular structure. The internal structures of the air storage cylinder are connected into one piece through the tensile ribs and the center columns, so that even if an air pressure in the cylinder is obviously higher than an air pressure outside the cylinder, the air storage cylinder can still maintain a complete structure.

The center columns include an upper shell center column 51, an intermediate shell center column 52, and a lower shell center column 53. The upper shell center column 51 and the lower shell center column 53 are respectively arranged in the inner cavities of the upper shell 1 and the lower shell 3. One end of the upper shell center column 51 and one end of the lower shell center column 53 are connected with the inner walls of the end closure heads 11; the other ends of the upper shell center column 51 and the lower shell center column 53 are contracted on the inner side of the welding surface 7 on the upper shell 1 or the lower shell 3. The top of the tensile rib connected to the outer wall of the upper shell center column 51 or the lower shell center column 53 may be a gradually rising arc-shaped surface 43 from low to high in a direction from the circle center to the circumference. The intermediate shell center column 52 is arranged in the inner cavity of the intermediate shell 2. One end of the intermediate shell center column 52 is connected with the separation closure head 9, and the other end of the intermediate shell center column 52 is contracted on the inner side of the welding surface 7 of the other end of the intermediate shell 2. One end surface of the tensile rib connected to the intermediate shell center column 52 is connected with the separation closure head 9; the other end of the tensile rib connected to the intermediate shell center column 52 may be a gradually rising arc surface 43 from low to high in a direction from the circle center to the circumference. The center column may be circular and may also be a polygon whose side number is the same as that of small arc surfaces 61 that form the petal-like structure 6.

The tensile ribs may include first tensile ribs 41 and second tensile ribs 42. The first tensile ribs 41 may be arranged inside the upper shell 1, inside the lower shell 3 and inside the intermediate shell 2 away from the separation closure head 9. The second tensile ribs 42 may be arranged between the separation closure head 9 and the adjacent welding surfaces 7. The tops of the first tensile ribs 41 and the second tensile ribs 42 may be provided with gradually rising arc surfaces 43. Ends of the gradually rising arc surfaces 43 arranged on the first tensile ribs 41 and connected to the inner walls of the shells may be provided with flanges 411; and ends of the gradually rising arc surfaces 43 arranged on the second tensile ribs 42 and connected to the inner walls of the shells may be provided with Y-shaped ribs 421. Y-shaped connecting nodes can effectively improve the strength of the separation closure head 9. Meanwhile, the Y-shaped ribs during injection molding of a product can also effectively improve the fluidity of plastic and increase the size stability. On the whole, one end of the upper shell center column 51 and one end of the lower shell center column 53 are connected with the end closure heads 11, and the other ends are connected with the end surfaces of the shells through the gradually rising arc surfaces 43 and the flanges 411 and are inwards sunken into the end surfaces. The structure of the intermediate shell center column 52 is similar except that the plate-type flanges 411 are replaced with the Y-shaped ribs 421. At this time, a section of hollow area will be formed in connection parts between the upper shell 1 and the intermediate shell 2 as well as between the intermediate shell 2 and the lower shell 3. An air flow can be uniformly distributed in all the shells when passing through these positions.

End surfaces of the upper shell 1 and the lower shell 3 opposite to the end closure heads 11 and two end surfaces of the intermediate shell 2 are provided with welding surfaces 7. The shells around the positions where the welding surfaces 7 are provided on the upper shell 1, the intermediate shell 2, and the lower shell 3 may be thickened, and a thickness of the shell at the position may be 0.5 mm-10 mm greater than a thickness of the shell at other positions. The thicknesses of the shells around the welding surfaces 7 and the shells at other positions may be uniformly transitioned. There may be two kinds of welding surfaces 7, including ladder-shaped welding surfaces 71 and parallel-shaped welding surfaces 72. Each ladder-shaped welding surface 71 may include an annularly disposed outer baffle plate 73 and an annular welding rib 74 arranged in an inner ring of the outer baffle plate 73. A side of the welding rib 74 in the ladder-shaped welding surface 71 close to the outer baffle plate 73 may be uniformly provided with several welding bosses 711. Due to the existence of the welding bosses 711, on the one hand, the welding area may be enlarged; and on the other hand, when the welding bosses 711 and the welding ribs 74 are simultaneously softened, excess overflowing materials may be squeezed to both sides for filling. Compared with a single welding rib 74, this structure will achieve a better welding effect. Each parallel-shaped welding surface 72 may include an outer baffle plate 73 and an inner baffle plate 721 which are concentrically disposed in two circles; one circle of annular welding rib 74 may also be arranged between the outer baffle plate 73 and the inner baffle plate 721 in the parallel-shaped welding surface 72. After the welding ribs 74 are heated to be softened, the baffle plates arranged on two sides of the welding ribs 74 may prevent the overflow problem in the welding ribs 74 and may also enhance the welding effect. In an actual use process, the welding surface 7 on the upper shell 1, the intermediate shell 2, and the lower shell 3 may adopt any one of the ladder-shaped welding surface 71 and the parallel-shaped welding surface 72, and the welding surfaces may match, that is, the ladder-shaped welding surface 71 may cooperate with the ladder-shaped welding surface 71, and the parallel-shaped welding surface 72 may cooperate with the parallel-shaped welding surface 72.

Several connecting lugs 75 may be arranged on a peripheral circumference of each welding surface 7. The upper shell 1, the intermediate shell 2, and the lower shell 3 may be in welding connection with each other. And after the upper shell 1, the intermediate shell 2, and the lower shell 3 are connected by welding, bolts 14 and nuts 16 may also be arranged in the connecting lugs 75 for auxiliary connection to prevent cracking of the air storage cylinder due to long-time overuse. The nuts 16 may be separately disposed, or may be pre-buried in an injection molding process of the shells. Bush rings 15 may be arranged between the bolts 14 and the nuts 16. The bush ring 15 may not be used in actual installation. Double-peak knurled threads 161 may be formed on side surfaces of the nuts 16; each double-peak knurled thread 161 may be two annular plate bodies which are disposed at an interval and are provided with antiskid slots in outer circumferential surface. Air inlet/outlet joints 17 and sensor joints may be arranged on the end closure heads 11 of the upper shell 1 and the lower shell. A cavity 172 penetrating through the air inlet/outlet joints 17 may be formed in the middle of each air inlet/outlet joint 17. A three-peak knurled thread 171 may be formed on an outer side wall of the air inlet/outlet joint 17; the three-peak knurled thread 171 is three annular plate bodies which are disposed at an interval and are provided with antiskid slots in outer circumferential surfaces; a sealing ring slot is formed in a body of the air inlet/outlet joint 17 below the three-peak knurled thread 171. A sealing ring 173 may be arranged in the sealing ring slot. The sealing ring 173 can enhance the sealing effect of cooperation positions between the air inlet/outlet joints 17 and the shells. The air inlet/outlet joint 17 may be pre-buried in the injection molding process of the upper shell 1 and the lower shell 3. The end surface of the air inlet/outlet joint 17 that is provided with the three-peak knurled thread 171 may be flush with the outer end surface of the shell outer wall of the upper shell 1 or the lower shell 3; and the rest part of the air inlet/outlet joint 17 may be embedded into the shell. Arranging the double-peak knurled thread 161 and the three-peak knurled thread 171 is to ensure the pre-burying reliability of the nut 16 and the air inlet/outlet joint 17.

The side walls of the upper shell 1, the lower shell 3, and the intermediate shell 2 may be petal-like structures 6. Each petal-like structure 6 may be formed by connecting five or more small arc surfaces 61 in sequence, so that the side walls of the upper shell 1, the intermediate shell 2, and the lower shell 3 are formed into concave-convex petal appearances, and this state enlarges the surface areas of the inner and outer walls of the shells. When the air pressure inside the shell increases, on the one hand, stress on a unit shell will greatly decrease, and on the other hand, the curvature radius of the small arc surface 61 will be much smaller than that of a conventional cylindrical air storage cylinder shell, so that the single small arc surface 61 can bear higher internal and external pressures and has higher structural stability. By combining the small arc surfaces, the petal-like air storage cylinder with the structural strength much greater than that of the conventional cylindrical air storage cylinder can be obtained, thus solving the technical problem that the strength of the plastic air storage cylinder is generally substandard. Every two adjacent small arc surfaces 61 may be in rounded transition at an end surface intersection, and the petal-like structures 6 and the end closure heads 11 may also be in rounded transition. The rounded transition can reduce the problem of stress concentration. Reinforcing ribs 8 may be arranged on the outer walls of the upper shell 1, the intermediate shell 2, and the lower shell 3. A thickness of the reinforcing rib 8 may be 1 mm-5 mm. The reinforcing ribs 8 may be arranged to form any one kind of a radial arc pattern, a diamond pattern, a cross pattern, a honeycomb pattern, a square pattern, and a parallel pattern, or may also be in an annular distinguishing distribution. The reinforcing ribs 8 in petal-like contour areas on the outer walls of the upper shell 1 and the lower shell 3 may be arranged to form a cross pattern, and the reinforcing ribs 8 in non-petal-like contour areas, i.e., areas of the end closure heads 11, on the outer walls of the upper shell 1 and the lower shell 3 may be arranged to form a radial arc pattern. From the technological point of view, the reinforcing ribs 8 forming a radial arc pattern are easier to form, and their appearances are easier to control; and more materials are saved. However, in terms of the reinforcing effect, the reinforcing ribs forming a diamond pattern, a cross pattern, a honeycomb pattern, an a square pattern are better. The actual stress conditions of different areas of the air storage cylinder are not completely consistent, so that reinforcing ribs 8 in different patterns can be provided in different areas on the shells.

Drainage openings 13 may be formed in the side walls of the upper shell 1 and the intermediate shell 2. A mounting seat hole 12 is formed in the side wall of the intermediate shell 2, and asterisk-shaped reinforcing ribs 121 may be arranged around the mounting seat hole 12.

Several following embodiments are provided for the reinforced plastic air storage cylinder of the present disclosure:

In a first embodiment, the thicknesses of the tensile ribs and the reinforcing ribs 8 are 1 mm. The shells around the positions where the welding surfaces 7 are provided are thickened, and the thickness of the shell at the position is 0.5 mm greater than the thickness of the shell at other positions. The reinforcing ribs 8 forming a cross pattern are arranged outside the upper shell 1, the intermediate shell 2, and the lower shell 3, and the reinforcing ribs forming a radial arc pattern are arranged on the end closure heads 11. The end closure heads 11 and the separation closure head 9 are in a flat plate shape, and there are 5 small arc surfaces forming the petal-like structure 6. The nuts 16 are pre-buried in the injection molding process of the shells. The welding surfaces 7 adopt the parallel-shaped welding surfaces 72, and all the center columns are circular.

In a second embodiment, the thicknesses of the tensile ribs and the reinforcing ribs 8 are 2 mm. The shells around the positions where the welding surfaces 7 are provided are thickened, and the thickness of the shell at the position is 1 mm greater than the thickness of the shell at other positions. The reinforcing ribs 8 forming a diamond pattern are arranged outside the upper shell 1, the intermediate shell 2, and the lower shell 3. The end closure heads 11 and the separation closure head 9 hemispherical, and there are 7 small arc surfaces forming the petal-like structure 6. The nuts 16 and the bolts 14 are separately configured. The welding surfaces 7 adopt the ladder-shaped welding surfaces 71, and all the center columns are circular.

In a third embodiment, the thicknesses of the tensile ribs and the reinforcing ribs 8 are 2.5 mm. The shells around the positions where the welding surfaces 7 are provided are thickened, and the thickness of the shell at the position is 2 mm greater than the thickness of the shell at other positions. The reinforcing ribs 8 are in annular distinguishing distribution. The reinforcing ribs 8 in the petal-like contour areas on the outer walls of the upper shell 1 and the lower shell 3 are cross-shaped, and the reinforcing ribs 8 in the non-petal-like contour areas, i.e., the areas of the end closure heads 11, on the outer walls of the upper shell 1 and the lower shell 3 are reinforcing ribs forming a radial arc pattern. The end closure heads 11 adopt trapezoid closure heads that form a W shape together with the edge. The separation closure head 9 is hemispherical. There are 9 small arc surfaces forming the petal-like structure 6. The nuts 16 are pre-buried in the injection molding process of the shells. The welding surfaces 7 adopt the ladder-shaped welding surfaces 71, and all the center columns are polygons whose side number is the same as that of the small arc surfaces forming the petal-like structure 6.

In a fourth embodiment, the thicknesses of the tensile ribs and the reinforcing ribs 8 are 4 mm. The shells around the positions where the welding surfaces 7 are provided are thickened, and the thickness of the shell at the position is 5 mm greater than the thickness of the shell at other positions. The reinforcing ribs 8 are in annular distinguishing distribution. The reinforcing ribs 8 in the petal-like contour areas on the outer walls of the upper shell 1 and the lower shell 3 are arranged to form a cross pattern, and the reinforcing ribs 8 in the non-petal-like contour areas, i.e., the areas of the end closure heads 11, on the outer walls of the upper shell 1 and the lower shell 3 are arranged to form a radial arc pattern. The end closure heads 11 adopt trapezoid closure heads that form a W shape together with the edge. The separation closure head 9 is hemispherical. There are 11 small arc surfaces forming the petal-like structure 6. The nuts 16 are pre-buried in the injection molding process of the shells. The welding surfaces 7 adopt the ladder-shaped welding surfaces 71, and all the center columns are polygons whose side number is the same as that of the small arc surfaces forming the petal-like structure 6.

Finished products trial-produced in different embodiments are subjected to a mechanical test, and the following conclusion may be obtained.

Greater thicknesses of the tensile ribs and the reinforcing ribs 8 may improve the structural strength of the shells more obviously and consume more materials. Furthermore, when the tensile ribs are thicker, the effective volume of the inner cavity of the shell may also be reduced, so that the thicknesses of the tensile ribs and the reinforcing ribs 8 may be preferably 2.5 mm on conventional vehicles. The shells around the positions where the welding surfaces 7 are provided may be thickened, and the thickness of the shell at the position may be 1 mm or 1.5 mm greater than the thickness of the shell at other positions. It is not obvious to improve the welding surfaces 7 if the shells are too thick. A larger number of small arc surfaces 61 forming the petal-like structure 6 may achieve a better reinforcing effect on the shells, but due to the limitation of the process and materials, nine small arc surfaces work best in general. It may be more effective if the reinforcing ribs 8 are disposed more densely. However, the intermediate shell 2 may be stressed by the pressure of the air in the shells in the working process and also has a function of fixing the air storage cylinder, so that denser reinforcing ribs 8 forming a diamond pattern, a cross pattern, and a honeycomb pattern are preferentially arranged at this place. The end closure heads 11 are only stressed by the pressure of the internal air, so that the reinforcing ribs forming a radial arc pattern are enough. Pre-burying the nuts 16 will bring great convenience in the assembling process of the shells. The regularly polygonal center columns may more greatly improve the structural strength of the shells, so the center columns in this shape may be preferred. The arc shape of the end closure heads 11 may be most preferable. At this time, the volume and structural strength of the inner cavity of the air storage cylinder may achieve an optimal balance point. The middle section of the separation closure head 9 may be a trapezoid. When it is W-shaped on the whole, the separation closure head has the highest anti-air impact capability.

The present disclosure provides a reinforced plastic air storage cylinder. By arranging the tensile ribs and the center columns inside the shells of the air storage cylinder and arranging the reinforcing ribs outside the shells, the structural strength of the plastic air storage cylinder can be greatly improved, so that mass production of the plastic air storage cylinder can be achieved and the usage requirements in various systems of automobiles can be met. The uniquely designed petal-like structures can greatly reduce the curvature radius of the outer wall of each shell and improve the structural strength of the outer wall of the shell. The W-shaped separation closure head can cope with the impact of air flow generated by small and large cavities in the air storage cylinder in inflating and deflating processes and prevent the air flow from breaking through the closure head and then damaging the double-cavity structure of the air storage cylinder. The welding bosses are additionally arranged on the welding ribs in the ladder-shaped welding surfaces. On the one hand, the welding area may be enlarged. On the other hand, when the welding bosses and the welding ribs are simultaneously softened, excess overflowing materials may be squeezed to both sides for filling. Compared with a single welding rib, this structure will achieve a better welding effect. The Y-shaped reinforcing ribs are arranged between the separation closure head and the adjacent welding surfaces, which can effectively improve the strength of the separation closure head. At the same time, the Y-shaped reinforcing ribs may effectively improve the fluidity of plastic during injection molding of a product, thereby ensuring the size stability. The reinforced plastic air storage cylinder overall has the features of light weight, low cost, high structural strength, and the like; the objective of lightweight design of an air storage cylinder is achieved; and the air storage cylinder has an extremely high popularization significance.

The disclosure has been exemplarily described above in conjunction with the accompanying drawings. Obviously, the specific implementation of the present disclosure is not limited by the above manner. Such insubstantial improvements adopting the concept and technical solution of the method of the present disclosure, or direct applications of the concept of technical solution of the disclosure to other occasions without improvements all fall within the protection scope of the present disclosure.

What is claimed is:

1. A reinforced air storage cylinder comprising:
an upper shell comprising a first inner volume, a first inner wall defining the first inner volume, and a first outer frame comprising reinforcing ribs connected to an exterior surface of the first inner wall to provide structural support thereto, wherein the first inner wall comprises a plurality of arc segments connected together to form petal-like structures wherein the plurality of arc segments of the first inner wall forms a plurality of peaks projecting into the first inner volume at locations where adjacent arc segments of the plurality of arc segments of the first inner wall connect to one another;
a first center column positioned in the first inner volume;
a first set of tensile ribs wherein each tensile rib of the first set of tensile ribs comprises one end connecting to the first center column and an opposite end extending in a radial direction away from the first center column and securing to the first inner wall proximate a peak of the plurality of peaks of the first inner wall; and
a lower shell comprising a second inner volume.

2. The reinforced air storage cylinder of claim 1, wherein the plurality of arc segments of the first inner wall comprises at least five arc segments.

3. The reinforced air storage cylinder of claim 1, wherein:
the first center column extends along an axial direction;
a cross-sectional shape of the first center column is a circle or a polygon having one side for each arc segment of the plurality of arc segments of the first inner wall, wherein a cross section corresponding to the cross-sectional shape extends perpendicular to the axial direction.

4. The reinforced air storage cylinder of claim 1, wherein the lower shell further comprises:
a second inner wall defining the second inner volume, wherein the second inner wall comprises a plurality of arc segments connected together to form petal-like structures wherein the plurality of arc segments of the second inner wall forms a plurality of peaks projecting into the second inner volume at locations where adjacent arc segments of the plurality of arc segments of the second inner wall connect to one another;
a second outer frame comprising reinforcing ribs connected to an exterior surface of the second inner wall to provide structural support thereto;
a second center column positioned in the second inner volume; and
a second set of tensile ribs wherein each tensile rib of the second set of tensile ribs comprises one end connecting to the second center column and an opposite end extending in a radial direction away from the second center column and securing to the second inner wall proximate a peak of the plurality of peaks of the second inner wall.

5. The reinforced air storage cylinder of claim 1, further comprising at least one intermediate shell comprising a third inner volume, wherein the upper shell closes off one end of the at least one intermediate shell and the lower shell closes off an opposite end of the at least one intermediate shell.

6. The reinforced air storage cylinder of claim 5, wherein the at least one intermediate shell further comprises:
a third inner wall defining the third inner volume, wherein the third inner wall comprises a plurality of arc segments connected together to form petal-like structures wherein the plurality of arc segments of the third inner wall forms a plurality of peaks projecting into the third inner volume at locations where adjacent arc segments of the plurality of arc segments of the third inner wall connect to one another;
a third outer frame comprising reinforcing ribs connected to an exterior surface of the third inner wall to provide structural support thereto;
a third center column positioned in the third inner volume; and
a third set of tensile ribs wherein each tensile rib of the third set of tensile ribs comprises one end connecting to the third center column and an opposite end extending in a radial direction away from the third center column and securing to the third inner wall proximate a peak of the plurality of peaks of the third inner wall.

7. The reinforced air storage cylinder of claim 6, wherein the opposite end of each tensile rib of at least one of the first, second, and third set of tensile ribs branches into two rib segments that capture therebetween the peak of the plurality of peaks of the first, second, and third inner wall corresponding thereto.

8. The reinforced air storage cylinder of claim 5, wherein:
the upper shell is connected to the at least one intermediate shell by at least one of a fastener or a welding connection; and
the lower shell is connected to the at least one intermediate shell by at least one of a fastener or a welding connection.

9. The reinforced air storage cylinder of claim 6, further comprises a separation closure head comprising a wall extending substantially orthogonal to a central axis of the at least one intermediate shell so as to axially divide the at least one intermediate shell into two cavities.

10. The reinforced air storage cylinder of claim 9, wherein an outer perimeter of the separation closure head extends obliquely to meet the third inner wall.

11. The reinforced air storage cylinder of claim 9, wherein the separation closure head is in one shape selected from the group consisting of a hemisphere shape, a flat plate shape, a dish shape, a cone shape, and a trapezoid shape.

12. The reinforced air storage cylinder of claim 1, wherein the reinforcing ribs are arranged to form at least one pattern selected from the group consisting of a radial arc pattern, a diamond pattern, a cross pattern, a honeycomb pattern, a square pattern, and a parallel pattern.

13. The reinforced air storage cylinder of claim 12, wherein the reinforcing ribs are arranged to form multiple patterns comprising the cross pattern and the radial arc pattern.
